(19) United States
(12) Patent Application Publication
(10) Pub. No.: US 2020/0175839 A1
(43) Pub. Date: Jun. 4, 2020

(54) AUTOMATIC ALARM SYSTEM FOR DETECTING SUDDEN CHANGES

(71) Applicant: TECOM CO., LTD., Hsin-Chu (TW)

(72) Inventors: Chen-Shun HUNG, Hsin-Chu (TW); Hsin-Rrong HUANG, Hsin-Chu (TW)

(21) Appl. No.: 16/248,088

(22) Filed: Jan. 15, 2019

(30) Foreign Application Priority Data
Nov. 29, 2018 (TW) 107142684

(51) Int. Cl. G08B 23/00; G08B 21/18

(52) U.S. Cl. CPC G08B 23/00; G08B 21/187; G08B 21/182

(57) ABSTRACT

An automatic alarm system is configured for automatically detecting a sudden-change event occurred in an electromechanical device located in a working area, and includes a detecting module, a memory, an alarm module, and a mobile device. The detecting module detects a plurality of data of the electromechanical device. The memory saves the data. The alarm module generates an alarm signal. The mobile device receives the alarm signal and is utilized to allow a related person to remote control the electromechanical device.

This application claims the benefit of Taiwan Patent Application Serial No. 107142684, filed on Nov. 29, 2018, the subject matter of which is incorporated herein by reference.

### BACKGROUND OF THE INVENTION

### 1. Field of the Invention

The invention relates to an alarm system, and more particularly to an automatic detection and alarm system for sudden changes.

### (2) Description of the Prior Art

With variety of various industrial developments, versatile electromechanical devices to meet different industrial or business applications have been provided. In these electromechanical devices, frequent or periodic inspection or service by specific inspection system is usually needed, such that abnormality to these electromechanical devices can be substantially reduced.

Generally speaking, a conventional inspection or detection system is usually furnished with upper and lower limits to individual inspection items. As one inspection item detects a value beyond the corresponding upper or lower limit, the inspection system would issue an alarm signal or message to a monitor end or person. In the art, these inspection items include vibrations (fluctuations), temperatures, voltages and currents.

Nevertheless, in practice, one monitor end would be in charge of plural electromechanical devices. Thus, when the monitor end receives an alarm signal, a service person away from the monitor end may be sent to the problem electromechanical device for rescue maintenance, or the monitor person may sent a service person adjacent to the problem electromechanical device for necessary service. Before the service person can arrive, the problem electromechanical device having the alarm signal may still keep running, and thus a possible breakdown to the problem electromechanical device might be met. Much seriously, the long-awaited problem electromechanical device may jeopardize the neighboring people or properties. In addition, conventionally, a remote maintenance at the monitor end or for the monitor person is seldom a choice for maintaining the problem electromechanical device.

In addition, the conventional inspection system can only issue the alarm signal upon when the detection value goes beyond the corresponding upper or lower limit. In the case that the detection value rises or drops severely or suddenly but still within the corresponding upper or lower limit, the conventional inspection system usually respond null. Namely, to the conventional inspection system, the alarm signal may stand for an irreversible situation to the problem electromechanical device, and quite possible the alarm signal is simply a pale message telling that the problem electromechanical device will be eventually dead.

### SUMMARY OF THE INVENTION

Accordingly, in view of the prior art described above, the conventional inspection system can only issue the alarm signal upon when the detection value exceeds the corresponding upper or lower limit, and thus a preventive step can be never adopted. Also, in the art, while the monitor end receives the alarm signal, a remote control method for maintaining directly the problem electromechanical device can't be applied. Thus, it is an object of the present invention to provide an automatic detection and alarm system for sudden changes, which would issue a sudden-change alarm signal upon when an electromechanical device within the system meets a sudden-change event. In addition, a mobile service person can utilize a movable communication device to directly control the electromechanical device of the system provided by this present invention.

In the present invention, the automatic detection and alarm system for sudden changes, applied to automatically transmit a sudden-change alarm signal upon when an electromechanical device positioned at a coordinate spot is detected to have a sudden-change event, includes a detecting module, a detection-data collecting and storing module, a sudden-change judging and alarming module, and a movable communication device.

The detecting module, furnished to the electromechanical device, is to detect the electromechanical device to obtain a plurality of detection information in a detection time order.

The detection-data collecting and storing module, connected communicatively with the detecting module, is to collect and store the plurality of detection information.

The sudden-change judging and alarming module, coupled electrically with the detection-data collecting and storing module and preset with a predetermined sampling number and a sudden-change judging criterion, is to capture orderly the predetermined sampling number of the detection information out of the plurality of detection information in the detection time order for forming a sequential-sampled detection-information group, and further to analyze the sequential-sampled detection-information group for obtaining a corresponding group of instant variation flags. When the group of instant variation flags satisfy the sudden-change judging criterion, the electromechanical device is determined to have a sudden-change event, and the corresponding sudden-change alarm signal is issued.

The movable communication device, connected communicatively with the sudden-change judging and alarming module and the electromechanical device and carried by a mobile service person, is to receive the sudden-change alarm signal, and includes a positioning module and a control module. The positioning module, recorded with a work-area division coordinate of the coordinate spot, is to position the movable communication device for obtaining a communication-device position coordinate. The control module, coupled electrically with the positioning module, is to receive the sudden-change alarm signal, and displays an operational interface respective to the electromechanical device having the sudden-change event for the mobile service person to operate thereon to transmit an operation signal to the electromechanical device having the sudden-change event upon when the communication-device position coordinate is determined to locate out of the work-area division coordinate.

In one embodiment of the present invention, the detecting module includes at least one of an accelerometer, a temperature detector, a voltage detector and a current detector.

In one embodiment of the present invention, the detecting module further includes an A/D converter for converting the plurality of detection information into a digital signal to be further transmitted to the detection-data collecting and storing module for storage.

In one embodiment of the present invention, the detection-data collecting and storing module and the sudden-change judging and alarming module are furnished to a gateway.

In one embodiment of the present invention, the detection-data collecting and storing module includes a detection-data collecting interface and a storage unit. The detection-data collecting interface, connected communicatively with the detecting module, is to collect the plurality of detection information. The storage unit, coupled electrically with the detection-data collecting interface, is to store the plurality of detection information.

In one embodiment of the present invention, the sudden-change judging and alarming module includes a data-sampling unit, a sudden-change judging unit and an alarm-communicating unit. The data-sampling unit, recorded with the predetermined sampling number, is to capture orderly the predetermined sampling number of the detection information out of the plurality of detection information in the detection time order for forming a sequential-sampled detection-information group. The sudden-change judging unit, coupled electrically with the data-sampling unit and furnished with the sudden-change judging criterion, is to analyze the sequential-sampled detection-information group for obtaining the corresponding group of instant variation flags. When the group of instant variation flags satisfy the sudden-change judging criterion, the electromechanical device is determined to have a sudden-change event, and the corresponding sudden-change alarm signal is issued. The alarm-communicating unit, coupled electrically with the sudden-change judging unit, is to transmit the sudden-change alarm signal to the movable communication device.

In one embodiment of the present invention, the control module includes a position-determining unit and a touch-and-display unit. The position-determining unit, coupled electrically with the positioning module, is to determine whether or not the communication-device position coordinate is located out of the work-area division coordinate. The touch-and-display unit displays a map information further displaying a district image of the work-area division coordinate and a coordinate spot of the communication-device position coordinate, and displays the operational interface respective to the electromechanical device having the sudden-change event for the mobile service person to operate thereon to transmit the operation signal upon when the mobile service person touches the district image respective to the electromechanical device having the sudden-change event.

In one embodiment of the present invention, the electromechanical device is coupled electrically with an operation-signal transceiver interface, the movable communication device further includes a wireless communication module, and the wireless communication module is coupled electrically with the touch-and-display unit, so that the operation signal is transmitted to the electromechanical device having the sudden-change event via the operation-signal transceiver interface.

As stated, by providing the automatic detection and alarm system for sudden changes in accordance with the present invention, a sudden-change alarm signal can be issued upon when the electromechanical device meets a sudden change, and thus a movable communication device can be applied to remote control the electromechanical device having the sudden-change event.

All these objects are achieved by the automatic detection and alarm system for sudden changes described below.

### BRIEF DESCRIPTION OF THE DRAWINGS

The present invention will now be specified with reference to its preferred embodiment illustrated in the drawings, in which:

FIG. 1A and FIG. 1B are together to show schematically, in a block view, an embodiment of the automatic detection and alarm system for sudden changes in accordance with the present invention;

FIG. 2 shows schematically the position-determining unit of the control module of the movable communication device of the embodiment of FIG. 1A and FIG. 1B; and

FIG. 3 shows schematically the touch-and-display unit of the control module of the movable communication device of the embodiment of FIG. 1A and FIG. 1B.

### DESCRIPTION OF THE PREFERRED EMBODIMENT

The invention disclosed herein is directed to an automatic detection and alarm system for sudden changes. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

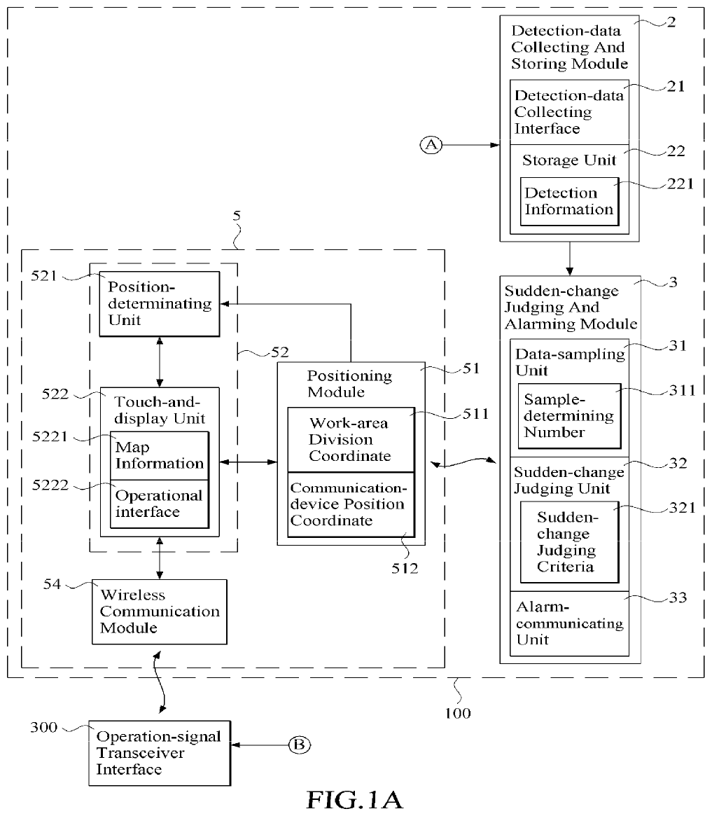

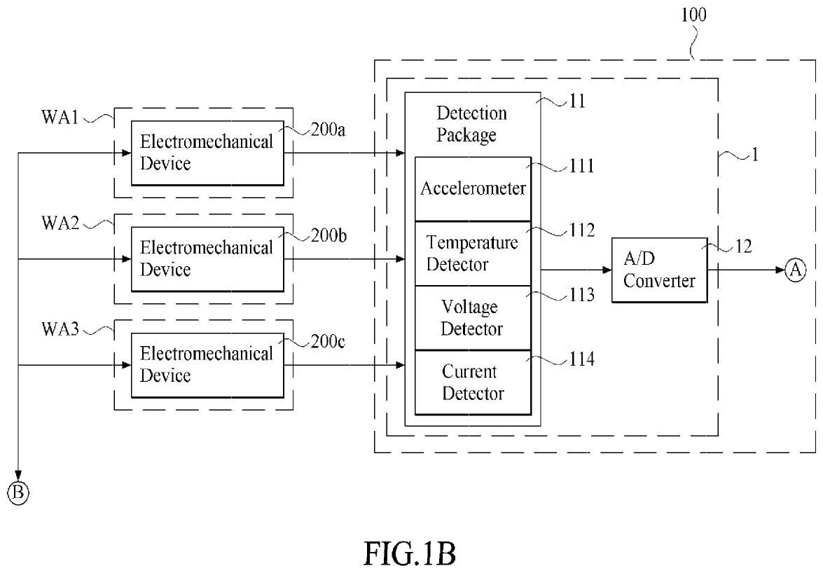

Referring now to FIG. 1A and FIG. 1B integrally, an embodiment of the automatic detection and alarm system for sudden changes in accordance with the present invention is schematically shown in a block view. As shown, the automatic detection and alarm system for sudden changes 100 includes a detecting module 1, a detection-data collecting and storing module 2, a sudden-change judging and alarming module 3 and a movable communication device 5.

The automatic detection and alarm system for sudden changes 100 can transmit automatically a sudden-change alarm signal, upon when a sudden-change event is detected at an electromechanical device located at a coordinate spot. In this embodiment, three electromechanical devices 200a, 200b, 200c are illustrated. The electromechanical devices 200a, 200b, 200c can be disposed at coordinate spots WA1, WA2, WA3, respectively. In other embodiment of the present invention not shown here, a plurality of the electromechanical devices can be included.

The detecting module 1, preferably located adjacent to the electromechanical devices 200a, 200b, 200c, is used to detect these three electromechanical devices 200a, 200b, 200c so as to obtain a plurality of detection information 221 in a detection time order. The detecting module 1 includes a detection package 11 and an A/D converter 12. The detection package 11 includes at least one of an accelerometer 111, a temperature detector 112, a voltage detector 113 and a current detector 114. In this embodiment, the detection package 11 includes all of the accelerometer 111, the he temperature detector 112, the voltage detector 113 and the current detector 114. Thus, the detection information 221 would include oscillation data, temperature data, voltage data and current data. The A/D converter 12, coupled electrically with detection package 11, is to convert the aforesaid detection information into a corresponding digital signal, and then transfer this digital signal to the detection-data collecting and storing module 2 for storage.

The detection-data collecting and storing module 2, connected communicatively with the detecting module 1, is used to collect and store the aforesaid detection information. The detection-data collecting and storing module 2 includes a detection-data collecting interface 21 and a storage unit 22. The detection-data collecting interface 21, connected communicatively with the detecting module 1, is used to collect the detection information 221. The storage unit 22, coupled electrically with the detection-data collecting interface 21, is used to store the detection information 221, and can be a memory, a flash memory, a memory chipset, a register or the like component that can be used for storing the detection information.

The sudden-change judging and alarming module 3, coupled electrically with the detection-data collecting and storing module 2, includes a data-sampling unit 31, a sudden-change judging unit 32 and an alarm-communicating unit 33. Preferably, the detection-data collecting and storing module 2 and the sudden-change judging and alarming module 3 can be integrated into a gateway in a modulation manner.

The data-sampling unit 31, recorded with a predetermined sampling number 311, is to sample the detection information 221 discretely in the detection time order so as to capture orderly data from the detection information 221 in a number equal to the predetermined sampling number, such that a sequential-sampled detection-information group can be formed by these sampled data from the detection information 221. The sudden-change judging unit 32, coupled electrically with the data-sampling unit 31 and furnished with a sudden-change judging criterion 321, is to analyze the sequential-sampled detection-information group for obtaining a group of instant variation flags, and then to issue a sudden-change alarm signal upon when the instant variation flags satisfy the sudden-change judging criterion 321. In an exemplary example, the sudden-change judging unit 32 can be a chip for performing a specific algorithm. The alarm-communicating unit 33, coupled electrically with the sudden-change judging unit 32, is to forward the sudden-change alarm signal to the movable communication device 5.

The detection information 221 shall be big enough for providing the predetermined sampling number of data to be captured by the data-sampling unit 31, in which the predetermined sampling number of data sampled from the detection information 221 are clustered as the sequential-sampled detection-information group. Preferably, the number of the detection information 221 is equal to the predetermined sampling number. Namely, the data-sampling unit 31 is operated in a real-time manner to provide the predetermined sampling number of the detection information 221.

It shall be explained that the data-sampling unit 31 is to perform orderly data sampling upon the detection information 221 according to the detection time order. Thus, the corresponding instant variation flags can be obtained meaningfully. If the data-sampling unit 31 can't perform data capturing upon the detection information 221 in accordance with the detection time order, then the sudden-change judging unit 32 would never provide a correct judgment from the instant variation flags. For example, the data-sampling unit 31 can perform the data sampling upon the detection information 221 in an order of the first second, the second second and the third second, or in another order of the first second, the third second and the fifth second, but never a random order of the first second, the fifth second and then back to the second second.

The sudden-change judging criterion 321 is a criterion to evaluate a trend, a slope, a percentage or a rate of the instant variations of the detection information 221. In the following table as an exemplary example, the detection information 221 is set to be the temperature of the electromechanical device 200a, and the sudden-change judging criterion 321 is set to be a ±5% variation range upon the temperature. If any instant variation flag does not fulfill the sudden-change judging criterion 321, then a sudden-change alarm signal will be issued.

| Time | Detection information | Instant variation flag |
|---|---|---|
| (s) | 221, °C. | (percentage) |
| 1 | 50 | — |
| 2 | 51 | 2% |
| 3 | 57 | 11.76% |
| 4 | 58 | 1.75% |
| 5 | 56 | −3.45% |

As shown in the table, at the second and third seconds, the detected temperature is risen from 51° C. to 57° C., i.e., an instant variation flag of 11.76%, which exceeds definitely the +5% variation range for the sudden-change judging criterion 321. It implies that the electromechanical device 200a meets an unacceptable sudden rise in the detection information 221, and thus the sudden-change judging unit 32 would determine that the electromechanical device 200a is facing a sudden-change event, which is qualified for the sudden-change judging unit 32 to issue a corresponding sudden-change alarm signal. Thereupon, an object of the present invention to prevent the electromechanical device from an irretrievable abnormality can be achieved. If the electromechanical device 200a is a water pump, an abrupt temperature rise implies that the water pump has met a terrible no-water cycle pumping sands, dirts, pebbles, or the like.

As described above, the detection information 221 can be the voltage, the current or the oscillatory data. When the voltage is abruptly changed, it implies that the power supply to the electromechanical device might meet and abnormal situation. When the current is abruptly changed, it implies that an insulation coating of the internal coil of the electromechanical device might be broken. When the oscillatory data shows an abnormal offset at the electromechanical device, then the corresponding vibrations may be serious, the balance might be lost, the foundation might be distorted, and the supported might be shaken. In this embodiment, the instant variation flag is clearly the percentage. However, in another embodiment of the present invention, the instant variation flag can be a value. Generally speaking, for the current, the voltage or the temperature to the subject for investigation, the instant variation flag is preferable to be a percentage. On the other hand, if the oscillatory data is the subject, then the instant variation flag is preferable to be a value.

In some other embodiments, the detection information 221 can be compared, each by each, with the sequential-sampled detection-information group. By having the table listed above as an example, the detection information 221 at the fifth second can be compared in order with that at the first second, that at the second second, that at the third second, and that at the fourth second, so that the corresponding instant variation flags (by percentage) can be obtained. If any of the instant variation flags exceeds the ±5% range, it implies immediately that the detection information 221 of the electromechanical device 200a meets a sudden change. The determination of the sudden change by the sudden-change judging criterion is quite sensitive, so that the prevention in advance can be obtained. In addition, the sudden-change judging criterion for determining a sudden change of the detection information 221 at the electromechanical device 200a can be set to any two or more instant variation flags exceeding the ±5% range. Upon such an arrangement, the sudden change can be logically used to symbolize directly the changes at the electromechanical device 200a. In practice, the sequential-sampled detection-information group can include the detection information 221 at the 60th second.

The movable communication device 5, connected communicatively with the sudden-change judging and alarming module 3 and the electromechanical devices 200a, 200b, 200c, can be carried by a mobile service person to receive the sudden-change alarm signal. The movable communication device 5 includes a positioning module 51, a control module 52 and a wireless communication module 54. The control module 52 further includes a position-determining unit 521 and a touch-and-display unit 522.

The positioning module 51, recorded with the work-area division coordinates 511 for the coordinate spots WA1, WA2, WA3, is used to position the movable communication device 5 so as to obtain the corresponding communication-device position coordinate 512. In this embodiment, the work-area division coordinate 511 includes the work-area division coordinate of the coordinate spot WA1, the work-area division coordinate of the coordinate spot WA2, and the work-area division coordinate of the coordinate spot WA3.

The position-determining unit 521, coupled electrically with the positioning module 51, is used to determine whether or not the communication-device position coordinate 512 is located out of the work-area division coordinate 511.

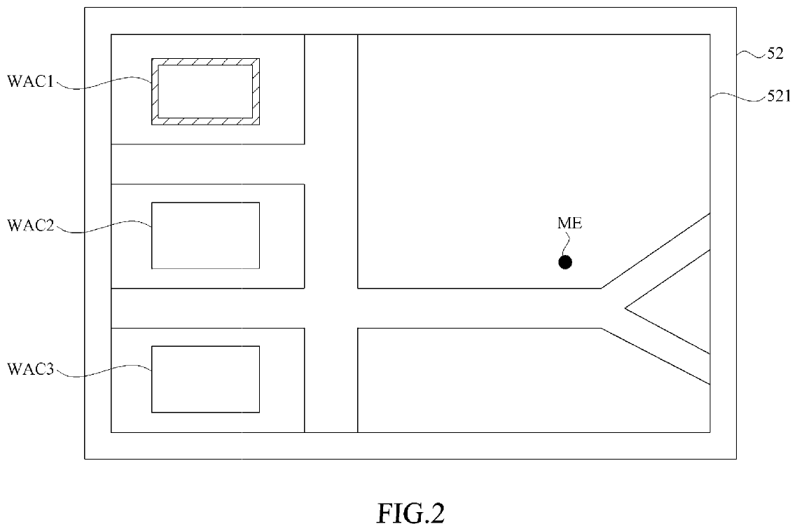

The touch-and-display unit 522 displays a map information 5221, and the map information 5221 further displays district images WAC1, WAC2, WAC3 (referred to FIG. 2) of the work-area division coordinate 511 and a coordinate spot ME (referred to FIG. 2) of the communication-device position coordinate 512. In addition, while the mobile service person touches the district image (WAC1) in correspondence with the electromechanical device having the sudden-change event (the electromechanical device 200a for example), the touch-and-display unit 522 can display an operational interface 5222 of the electromechanical device having the sudden-change event for the mobile service person to operate thereon for transmitting an operation signal.

In this embodiment, the electromechanical devices 200a, 200b, 200c are coupled electrically with an operation-signal transceiver interface 300. The wireless communication module 54, coupled electrically with the touch-and-display unit 522, is used to transmit the operation signal to the electromechanical device having the sudden-change event (the electromechanical device 200a for example) via the operation-signal transceiver interface 300.

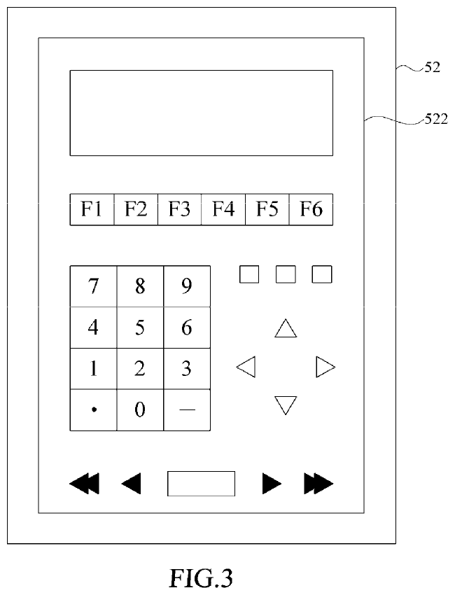

Refer now to FIG. 1A through FIG. 3; where FIG. 2 shows schematically the position-determining unit of the control module of the movable communication device of the embodiment of FIG. 1A and FIG. 1B, and FIG. 3 shows schematically the touch-and-display unit of the control module of the movable communication device of the embodiment of FIG. 1A and FIG. 1B.

As shown, when the movable communication device 5 receives the sudden-change alarm signal, the position-determining unit 521 would judge if or not the communication-device position coordinate 512 is located out of the work-area division coordinate 511. In this embodiment, the communication-device position coordinate 512, disposed at the coordinate spot ME, is actually located out of the work-area division coordinate 511.

Hence, the touch-and-display unit 522 of the control module 52 displays a map information 5221 further displaying thereon the district images WAC1, WAC2, WAC3 of the work-area division coordinate 511 and the coordinate spot ME of the communication-device position coordinate 512. After the mobile service person clicks or selects the district image WAC1, the operational interface 5222 for the electromechanical device 200a having the sudden-change event would be furnished to provide the mobile service person to operate thereon and then transmit the operation signal. Thereupon, the electromechanical device 200a having the sudden-change event can be remotely controlled directly, such that the object of remote controlling the electromechanical device having the sudden-change event in a real-time manner can be obtained.

Generally speaking, the operation signal can be transmitted to the gateway, and then the gateway transmits a corresponding control signal to the controller (usually a PLC) of the electromechanical device, so that the electromechanical device can be controlled. Alternatively, the operation signal can be transmitted to the controller of the electromechanical device, so that the electromechanical device can be controlled directly.

In summary, by providing the automatic detection and alarm system for sudden changes in accordance with the present invention, a sudden-change alarm signal can be issued upon when the electromechanical device meets a sudden change, and thus a movable communication device can be applied to remote control the electromechanical device having the sudden-change event.

In comparison to the conventional design where the investigation system issues an alarm signal only upon when the electromechanical device is operated to exceed lower or upper limits, so that the monitor end of the conventional design cannot performs an effective remote control upon the problem electromechanical device, the system provided by the present invention can achieve objects of preventing the electromechanical device in advance from an irretrievable abnormality and remote controlling.

While the present invention has been particularly shown and described with reference to a preferred embodiment, it will be understood by those skilled in the art that various changes in form and detail may be without departing from the spirit and scope of the present invention.

What is claimed is:

1. An automatic detection and alarm system for sudden changes, applied to automatically transmit a sudden-change alarm signal upon when an electromechanical device positioned at a coordinate spot is detected to have a sudden-change event, comprising:
a detecting module, furnished to the electromechanical device, being to detect the electromechanical device to obtain a plurality of detection information in a detection time order;
a detection-data collecting and storing module, connected communicatively with the detecting module, being to collect and store the plurality of detection information;
a sudden-change judging and alarming module, coupled electrically with the detection-data collecting and storing module, preset with a predetermined sampling number and a sudden-change judging criterion, being to capture orderly the predetermined sampling number of the detection information out of the plurality of detection information in the detection time order for forming a sequential-sampled detection-information group, further to analyze the sequential-sampled detection-information group for obtaining a corresponding group of instant variation flags; wherein, when the group of instant variation flags satisfy the sudden-change judging criterion, the electromechanical device is determined to have a sudden-change event, and the corresponding sudden-change alarm signal is issued; and
a movable communication device, connected communicatively with the sudden-change judging and alarming module and the electromechanical device, carried by a mobile service person, being to receive the sudden-change alarm signal, including:
a positioning module, recorded with a work-area division coordinate of the coordinate spot, being to position the movable communication device for obtaining a communication-device position coordinate; and
a control module, coupled electrically with the positioning module, being to receive the sudden-change alarm signal, displaying an operational interface respective to the electromechanical device having the sudden-change event for the mobile service person to operate thereon to transmit an operation signal to the electromechanical device having the sudden-change event upon when the communication-device position coordinate is determined to locate out of the work-area division coordinate.

2. The automatic detection and alarm system for sudden changes of claim 1, wherein the detecting module includes at least one of an accelerometer, a temperature detector, a voltage detector and a current detector.

3. The automatic detection and alarm system for sudden changes of claim 1, wherein the detecting module further includes an A/D converter for converting the plurality of detection information into a digital signal to be further transmitted to the detection-data collecting and storing module for storage.

4. The automatic detection and alarm system for sudden changes of claim 1, wherein the detection-data collecting and storing module and the sudden-change judging and alarming module are furnished to a gateway.

5. The automatic detection and alarm system for sudden changes of claim 1, wherein the detection-data collecting and storing module includes:
a detection-data collecting interface, connected communicatively with the detecting module, being to collect the plurality of detection information; and
a storage unit, coupled electrically with the detection-data collecting interface, being to store the plurality of detection information.

6. The automatic detection and alarm system for sudden changes of claim 1, wherein the sudden-change judging and alarming module includes:
a data-sampling unit, recorded with the predetermined sampling number, being to capture orderly the predetermined sampling number of the detection information out of the plurality of detection information in the detection time order for forming a sequential-sampled detection-information group;
a sudden-change judging unit, coupled electrically with the data-sampling unit, furnished with the sudden-change judging criterion, being to analyze the sequential-sampled detection-information group for obtaining the corresponding group of instant variation flags; wherein, when the group of instant variation flags satisfy the sudden-change judging criterion, the electromechanical device is determined to have a sudden-change event, and the corresponding sudden-change alarm signal is issued; and
an alarm-communicating unit, coupled electrically with the sudden-change judging unit, being to transmit the sudden-change alarm signal to the movable communication device.

7. The automatic detection and alarm system for sudden changes of claim 1, wherein the control module includes:
a position-determining unit, coupled electrically with the positioning module, being to determine whether or not the communication-device position coordinate is located out of the work-area division coordinate;
a touch-and-display unit, displaying a map information, the map information further displaying a district image of the work-area division coordinate and a coordinate spot of the communication-device position coordinate, displaying the operational interface respective to the electromechanical device having the sudden-change event for the mobile service person to operate thereon to transmit the operation signal upon when the mobile service person touches the district image respective to the electromechanical device having the sudden-change event.

8. The automatic detection and alarm system for sudden changes of claim 7, wherein the electromechanical device is coupled electrically with an operation-signal transceiver interface, the movable communication device further includes a wireless communication module, and the wireless communication module is coupled electrically with the touch-and-display unit, so that the operation signal is transmitted to the electromechanical device having the sudden-change event via the operation-signal transceiver interface.
